(19) United States
(12) Patent Application Publication
(10) Pub. No.: US 2009/0268214 A1
(43) Pub. Date: Oct. 29, 2009

(54) PHOTOGRAMMETRIC SYSTEM AND TECHNIQUES FOR 3D ACQUISITION

(76) Inventors: Miljenko Lucic, Lachine (CA); Patrick Keraudren, Montreal (CA); Horia Balas, Pointe-Claire (CA); Yves Richer, St-Hilaire (CA)

Correspondence Address: OGILVY RENAULT LLP, 1, Place Ville Marie, SUITE 2500, MONTREAL, QC, H3B 1R1, CA

(21) Appl. No.: 12/301,715

(22) PCT Filed: May 26, 2006
(86) PCT No.: PCT/CA06/00877

§ 371 Date: Nov. 20, 2008

(51) Int. Cl. G01B 11/14; G06K 9/00

(52) U.S. Cl. 356/614; 382/154; 382/181

(57) ABSTRACT

A photogrammetric system and techniques applicable to photogrammetric systems in general are provided. The system provides the choice between the various types of light projection on the object to be measured and methods for retrieving 3D points on the object using a pattern projection method, a coded light method, and/or a method using intrinsic features of the object or a combination of such methods. A first technique provides camera position approximation using known distances between features. A second technique provides image processing parameters that take into account the local distance and orientation of the object to measured. A third technique provides the 3D correction of the position of the center of a sphere when imaging a spherical object.

### BACKGROUND

1) Field of the Invention

The invention relates to the measurement of any visible objects by photogrammetry. More particularly it relates to a system and techniques for the measurement of 3D coordinates of points by analyzing images of same.

2) Description of the Prior Art

3D Measurements are well known in the art and are widely used in the industry. The purpose is establishing the 3 coordinates of any desired point with respect to a reference point or coordinate system. As known in the prior art, these measurements can be accomplished with coordinate measuring machines (CMMs), teodolites, photogrammetry, laser triangulation methods, interferometry, and other contact and non-contact measurements. However all tend to be complex and expensive to implement in an industrial setting.

Applications of these systems and methods tend to be limited. Some are physically too large to be moved and easily applied, others require a lot of human intervention. Most require a relatively long data acquisition time where an object has to stand still. Furthermore, they are optimized for a specific object size. Thus, what is needed is a flexible, easily implemented system that can measure in a wide variety of industrial settings. A system performing measurements at sites radically varying by size and complexity, for example measurements in the construction industry as well as in continuous manufacturing processes, is needed.

### SUMMARY

In accordance with a first broad aspect of the present invention, there is provided a method for determining a position of a center of a spherical object being imaged, the method comprising: illuminating the spherical object using at least one light source to produce a light spot on the spherical object; acquiring at least two two-dimensional images of the spherical object with at least two image acquisition devices having known relative positions; calculating three-dimensional coordinates of the light spot using the at least two two-dimensional images; and determining the position of the center by identifying a point located one radial distance from the light spot and away from said camera.

In accordance with a second broad aspect of the present invention, there is provided a method for determining a position of an image acquisition device, the method comprising: (a) acquiring a 2D image comprising at least three features having known referent distances; (b) defining projection rays crossing each one of said features on said image and a known focal point of said image acquisition device; (c) arbitrarily choosing at least three points on said projection rays in front of said image acquisition device, said points having measurable relative current distances; (d) iteratively correcting positions of said at least three points on said projection rays by: i. defining a corrective coefficient k for each one of said at least three points by defining a ratio of a summation of said referent distances to a summation of said current distances, and ii. translating said at least three points along said projection rays using said corrective coefficient k; and (e) determining said position of said image acquisition device by performing a reference frame transformation.

In accordance with a third broad aspect of the present invention, there is provided a method for reconstructing an object from a plurality of two-dimensional images of the object, the method comprising: providing a set of parameters for features of the object, the parameters including at least one of shape and size; acquiring the plurality of images from different angles; reconstructing a set of points in three dimensions using standard photogrammetric techniques for the plurality of two-dimensional images; recalculating two-dimensional coordinates in the images by performing pattern recognition between features in the images and the parameters in accordance with appropriate feature-to-camera distances; and repeating the reconstructing using the two-dimensional coordinates determined using pattern recognition.

In accordance with a fourth broad aspect of the present invention, there is provided a 3D acquisition system for determining a 3D position of a feature in a scene, the system comprising: a light source having at least one of a light pattern projector for providing a projected pattern feature and a coded light projector for providing a coded light feature, said feature being one of said projected pattern feature, said coded light feature and a feature intrinsic of said scene; an image acquisition device for acquiring a first 2D data set of said scene; and an engine for locating said feature on said first 2D data set and on a second 2D data set and for determining said 3D position of said feature using said first and said second 2D data sets, said first and said second data sets being taken from different points of view, said engine having at least two of a projected pattern engine for said projected pattern feature, a coded light engine for said coded light feature, and an intrinsic feature engine said feature intrinsic to said scene.

In this specification, the term “feature” is intended to mean any identifiable feature on an object or a scene such as a light pattern, a coded light or the like projected on an object, an intrinsic feature of an object such as a corner, a hole, a recess, an image on its surface or a painted mark, or a reference feature disposed on or around the object, such as a target or a reference sphere.

### BRIEF DESCRIPTION OF THE DRAWINGS

Further features and advantages of the present invention will become apparent from the following detailed description, taken in combination with the appended drawings, in which:

FIG. 1 is a block diagram illustrating a 3D acquisition system according to an embodiment of the invention;

FIG. 2 is a flow chart showing a method of determining image processing parameters of images to be used in photogrammetry, according to one embodiment of the invention;

FIG. 3 is a schematic illustrating an image acquisition device position approximation method according to an embodiment of the invention and wherein the projection of three features on an image plane is represented; and

FIG. 4 is a schematic illustrating a method for determining a position of a center of a spherical object being imaged, according to an embodiment of the invention.

It will be noted that throughout the appended drawings, like features are identified by like reference numerals.

### DETAILED DESCRIPTION

For the photogrammetric reconstruction of points in three dimensions (3D), two or more photos of a scene are needed. Further, it is necessary to know the camera parameters and position for every photo taken. This requirement does not provide much flexibility and mobility for the method. Therefore, when camera positions are not known, camera position approximation is applied. Along with the measured object, a sufficient number of features need to be present in 2D images and they are used to find the positions of mobile camera(s) (or image acquisition devices) after the images are taken. Note that features are only needed if the camera positions and parameters are not already precisely known.

According to an embodiment of the invention, a photogrammetry method is divided into four broad steps, i.e image acquisition, calibration, point matching and 3D reconstruction.

2D images are acquired from different points of view of the scene using various image acquisition devices, such as still cameras, mobile cameras, digital cameras, video cameras, lasers, etc. Calibration of the images is required. A method known as bundle adjustment can be used in reconstruction of 3D points on an object. This method is an iterative process that combines a plurality of 2D images taken from different points of view to simultaneously determine the position and the orientation of the camera(s) and the coordinates of the measured points. This method is very powerful but requires the knowledge of certain calibration parameters, such as the focus and principal point of the camera and a camera position approximation. A method for providing a camera position approximation will be described further below. It should be noted that other calibration techniques, besides bundle adjustment, can be used and still require a method for providing camera position approximation.

During this calibration step, image processing parameters can also be determined. These parameters are used in the 2D and 3D processing of the images. Point matching in the images is a process that takes into account occlusions and noise effects. Furthermore, features in the scene are imaged with various angles and sizes. For example, a line can be 20 pixel wide in one image and 10 pixel wide in another. Image processing parameters may thus comprises shape correction, size correction, and intensity correction. These parameters also includes internal camera parameters, which may vary from one photo to another, like the focus and principal point used in the compensation phase. Further they also include specific parameters of the imaging device such as lens distortion correction parameters. These parameters are the radial, tangential and centering error correction parameters.

In order to perform 3D reconstruction, i.e. to obtain 3D coordinates points from a multiplicity of 2D points, 2D points that match, i.e. that results in same 3D points, have to be identified in a plurality of images taken from different points of view. The process of matching the points in the images can be manual or automatic. Automatic methods may include some operator assistance. Automatic methods comprise methods such as pattern matching.

3D information is restituted using a back-projective method. The image points define projection rays which are intersected in the reconstructed volume.

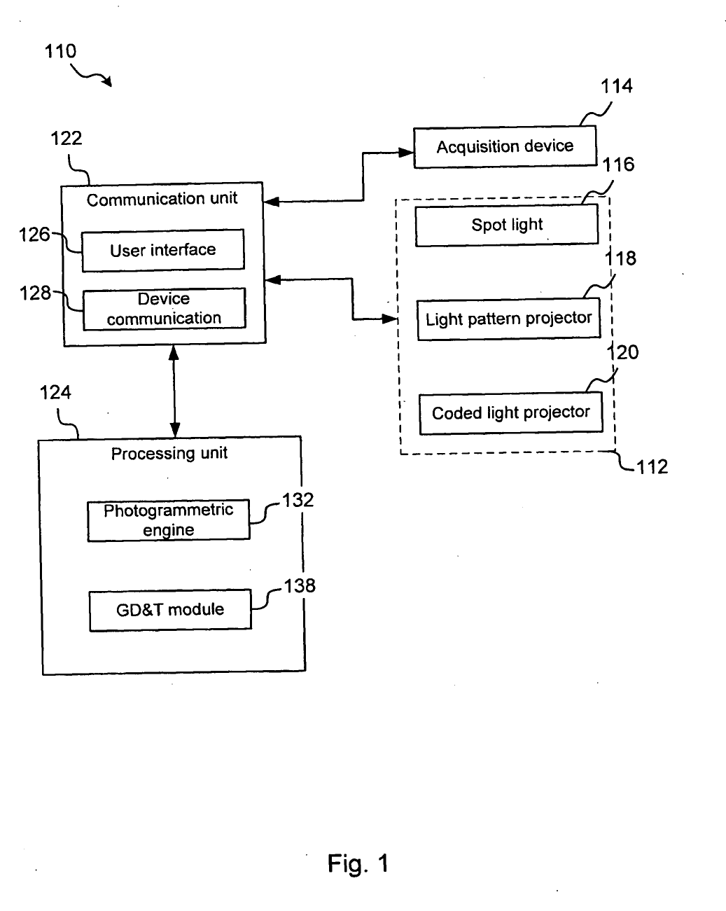

FIG. 1 illustrates a 3D acquisition system 110 using photogrammetric principles to restitute 3D points of an object or a scene and offering flexibility with respect to the features that can be used. This 3D acquisition system 110 provides a plurality of features that can be used in the reconstruction of 3D points on the object. The features can be intrinsic to an object or a scene, like corners, holes or reference features, or can be a projected light pattern or a projected coded light on the object. In any of these cases, the light or geometric features can be located on the 2D images and provide the basis for matching points of the 2D images taken from different points of view. This 3D acquisition system 110 provides three options, each associated with a light source 112. One option is to use only an ambient light or a spot light 116 as a light source 112. According to this option, the features that will be looked for in the images are features intrinsic to the scene. Another option is to use a light pattern projector 118 as a light source 112. The projected pattern produces on the scene light features that can be used in feature matching. The projected pattern may or may not be varied. Another option is to use a coded light projector 120 as a light source 112. According to this option, the coded light provides binary coded pixels on the 2D images. The code may be provided by sequentially projecting light patterns on the object with various frequencies.

2D images of the scene or the object are acquired using an image acquisition device 114. The image acquisition device 114 may comprise one or a pair of cameras with a known relative position and orientation. Only one camera may be used, if the relative position and orientation between the different points of view of the images is known or can be determined.

The 3D acquisition system 110 further comprises a communication unit 122 having a user interface 126 and a device communication module 128 for transmitting control instructions to the light source 112 and the image acquisition device 114 and for receiving the acquired 2D images from the image acquisition device 114. The acquired 2D images are processed by the processing unit 124. The processing unit 124 comprises a photogrammetric engine 132 for implementing calibration techniques, feature matching techniques and 3D reconstruction techniques.

Various inputs are provided to the photogrammetric engine 132: projected patterns (grids, etc), coded projection, white light. The choice between the various types of projections provides a system that can be adapted to the various possible object geometries and textures. Different processing methods can be combined in various ways. For example, when a white light is projected, the photogrammetric engine 132 will look for intrinsic features on the object, when a coded projection is used, the photogrammetric engine 132 will look for transitions in the image, when a grid is projected, the protogrammetric engine 132 will look for the geometric patterns related to the detection of a grid. In all cases, the protogrammetric engine 132 uses a series of pattern recognition methods that are able to manage the different inputs from the processing unit 124.

A Geometric Dimensioning & Tolerancing module (GD&T module) 138 can additionally be provided. While in some applications an inspection functionality can be omitted, according to an embodiment of the invention, the 3D acquisition system 110 is adapted to provide 3D geometry data of the object for its inspection. This data can be analyzed to check whether the object meets certain manufacturing tolerances. The GD&T module 138 provides an internationally compatible measurement tool in accordance with ASME Y 14.5M-1994 Dimensioning & Tolerancing Standard and ASME Standard.

According to GD&T standard, a target geometry of the manufactured object and allowable variation in the size and position of its features are defined. The geometry of the object is defined by distances between features present on the object such as a corner, a hole, a painted mark, and angles between edges and planes. Actual geometric shapes of the manufactured object are calculated from a restituted cloud of points. Given features are first fitted on the cloud of points for an estimation of their location in the reconstruction volume. The geometric shapes are calculated by the Best Fit method, a method also known as the “Minimum Square Error”, or “Maximum Likelihood” method. The software supports also the notion of “Robust Estimation”. This method allows for a percentage of points to be rejected from the point set to be considered based on its remoteness to the best fitted shape. The farthest point is rejected and the fit is repeated.

Determining a distance between sets of multiple points is based on calculating the average distance of a second set of points to a geometric shape best fitted through a first set. Angles are measured between any combinations of planes, circles and paths. The planes, circles and paths are determined by best fitting through measured points.

The 3D acquisition system 110 may implement one or more of the hereinafter described techniques. These techniques provide improved photogrammetry in appropriate circumstances.

Pattern Recognition

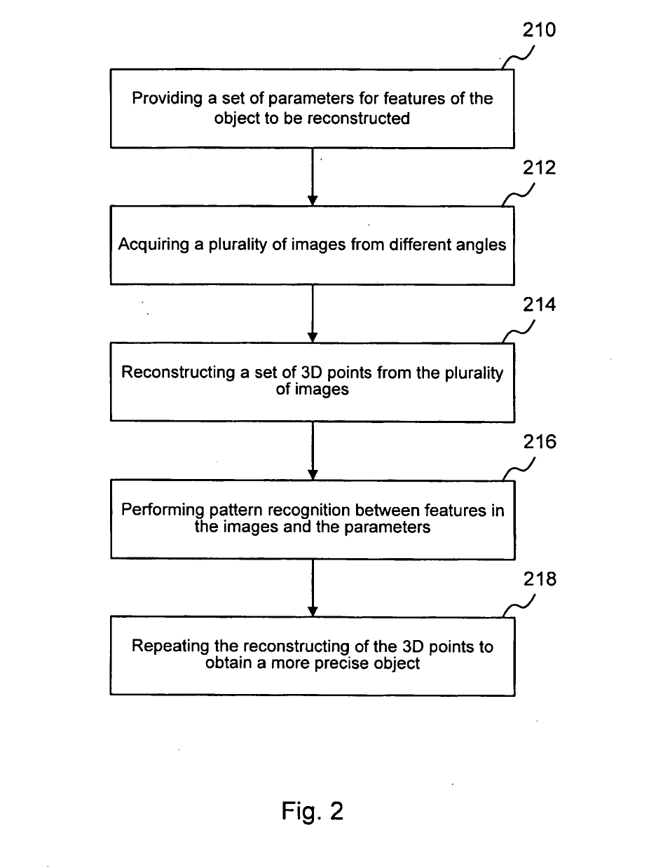

FIG. 2 illustrates a method for reconstructing an object from a plurality of two-dimensional images of the object taken from different angles. According to this method, features are located on the images and are linked to a set of parameters describing the shape, the amplitude, the bias and/or the size of the features. This method can have various applications. For example, this method can be used for recognizing features that will be used in GD&T or for recognizing reference features to be used for determining the position of the camera.

In step 210, a set of parameters for features that are to be recognized on the object is provided. For example, the parameters may comprise information about the shape, the amplitude, the bias or the size of the features. It should be appreciated that the shape, the amplitude, the bias or the size of the features may be refined based on the reconstructed points using iterative methods.

In step 212, a plurality of images are acquired from different angles. The acquired images may be taken with varying images settings, i.e. focal and exposure settings. Accordingly, for every feature to be recognized, the images taken with the most suitable settings may be chosen from the plurality of images. The best images may be chosen either manually or by an automated process.

In step 214, 3D points are reconstructed from the plurality of images using standard photogrammetric techniques. In step 216 the 2-D coordinates are recalculated in an optimal manner by pattern recognition between targets (or features) in the images and parameters (size and shape) appropriate for the target to camera distances, according to now known 3D positioning. New 3D positioning is calculated based on better 2D data 218. The parameters are used to refine the precision of the reconstructed volume. The parameters may be provided initially and stored in memory, or may be determined dynamically using various algorithms.

It is contemplated that steps 210, 214, 216 and 218 may be iteratively repeated using the refined reconstructed object.

According to an embodiment, in step 212, the best images settings are chosen using images previously acquired on a calibrated artifact. For every sub-portion, the image settings providing a reconstructed artifact having the best match with the calibrated artifact are selected.

Alternatively, in step 212, the image settings may be selected by finding the pair of images that provides the best match according to an image processing criteria such as the correlation coefficient between the two images of the pair.

It is also contemplated that, in step 210, the parameters may be interpolated or extrapolated for sub-portions where the parameters are initially unavailable.

Camera Position Approximation

As discussed above, a bundle adjustment method requires a first approximation of calibration parameters, such as the focus and principal point of the camera and a camera position approximation. According to an embodiment of the invention, a method for providing a camera position approximation is provided. In general, calibration of the camera position and parameters is performed by using known features that make-up part of the scene. First, these features are identified in the images. Their known positions in the scene (3D) and in the images (2D) make it possible to first find an approximation of the camera position for every acquired 2D image.

The camera position approximation software determines the camera position from information about reference features in each of the images. The reference features can be identified in the image by pattern recognition methods and the system determines the camera position without any operator assistance. Alternatively, if the number of machine recognizable reference features is not sufficient in one or more of the images then the user may identify the reference points.

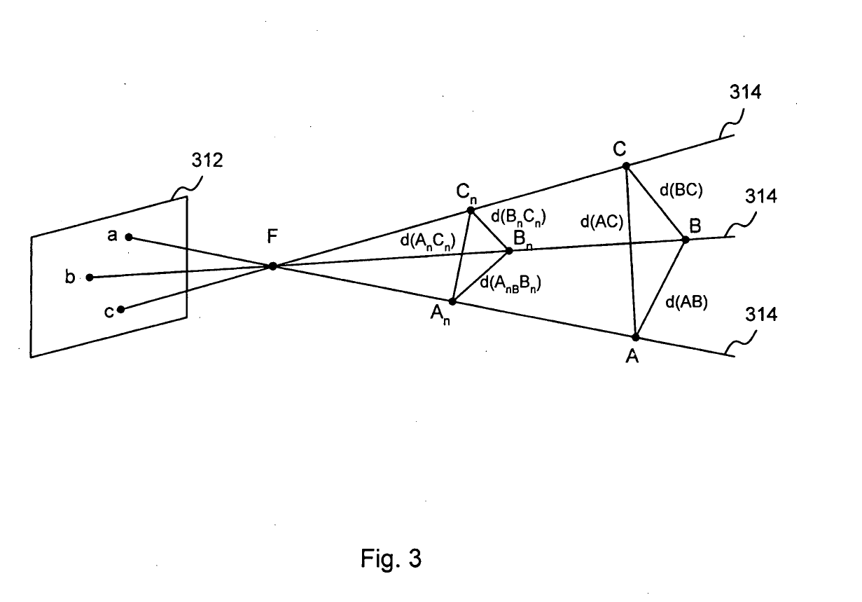

FIG. 3 illustrates a camera position approximation method according to an embodiment of the invention. This method uses known relative 3D position of at least three reference features A, B, C located in a scene. The relative positions are defined by known referent distances d(AB), d(AC), d(BC) between the reference features A, B, C. A 2D image of the scene is acquired. The image results from a projection of the reference features A, B, C on an image plane 312 and at least three projection points a, b, c are found on the image plane 312. The camera position approximation is calculated by first drawing projection rays 314 in space from the projection points a, b, c on the image plane 312 through the focal point F of the camera. An initial approximation of the 3D position of the reference features is made by arbitrarily choosing three points A₁, B₁, C₁ (not shown) on the projection rays 314 in the space in front of the camera. In an iterative process the positions of the points Aₙ, Bₙ, Cₙ in space are corrected until a satisfactory level of accuracy is reached. According to an embodiment, the correction is a corrective coefficient kA, kB, kC by which the points in space are moved closer or farther from the focal point F of the camera. While being moved, the points reside on their initial projection rays 314. The corrective coefficients are calculated using the distances d(AₙBₙ), d(AₙCₙ) and d(BₙCₙ) between the three estimated points Aₙ, Bₙ, Cₙ. The corrective coefficients kA, kB, kC for the three points Aₙ, Bₙ, Cₙ are calculated as follows:

$$kA = \frac{d ( AB ) + d ( AC )}{d ( {A}_{n} {B}_{n} ) + d ( {A}_{n} {C}_{n} )}$$

$$kB = \frac{d ( AB ) + d ( BC )}{d ( {A}_{n} {B}_{n} ) + d ( {B}_{n} {C}_{n} )}$$

$$kC = \frac{d ( AC ) + d ( BC )}{d ( {A}_{n} {C}_{n} ) + d ( {B}_{n} {C}_{n} )} .$$

The corrective coefficients kA, kB, kC are used to translate the points Aₙ, Bₙ, Cₙ, along the rays 314 to provide the next estimated points Aₙ₊₁, Bₙ₊₁, Cₙ₊₁. The distance d(FAₙ₊₁), d(FBₙ₊₁), d(FCₙ₊₁) between the focal point F and the next estimated points being a function of the distance d(FAₙ), d(FBₙ), d(FCₙ) between the focal point F and the estimated points and a function of the corrective coefficients kA, kB, kC. One possible translation is calculated as follows:

d(FAₙ₊₁)=μ×kA×d(FAₙ)

d(FBₙ₊₁)=μ×kB×d(FBₙ)

d(FCₙ₊₁)=μ×kC×d(FCₙ)

the damping coefficient μ being optional.

Alternatively, four or more reference features could be used for camera position approximation. In this case, the correction coefficient kA could be calculated as follows:

$$kA = \frac{d ( AB ) + d ( AC ) + d ( AD )}{d ( {A}_{n} {B}_{n} ) + d ( {A}_{n} {C}_{n} ) + ( {A}_{n} {D}_{n} )} ,$$

the remaining calculations being as previously described.

Spherical Object Center

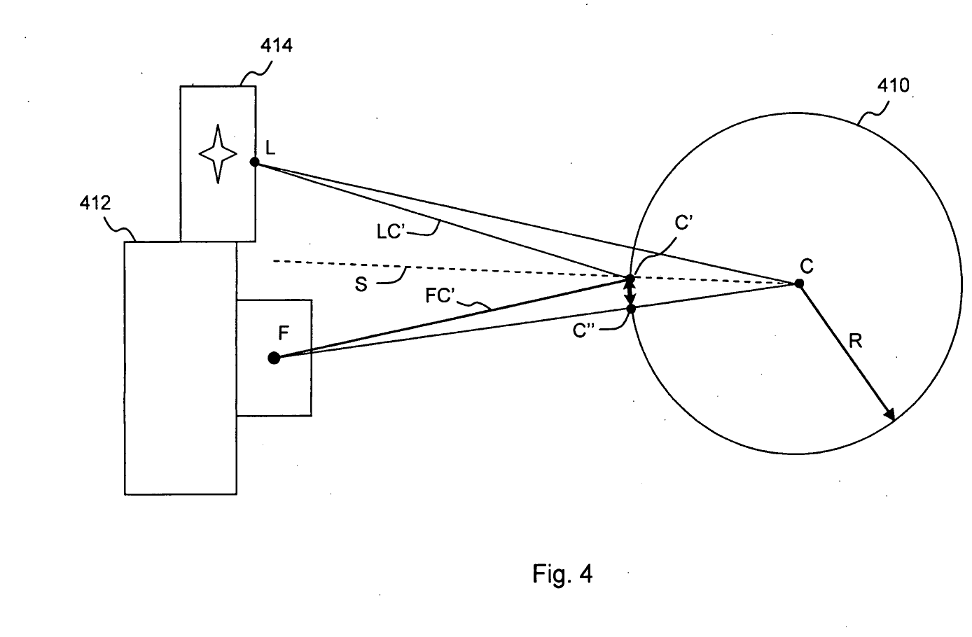

FIG. 4 illustrates a method for restituting a 3D position of the center C of a spherical object 410 based on photogrammetry. In a photogrammetric method, a spherical object 410 may be used as a feature disposed in a scene or on an object for reference purposes or it may be part of the features of the object to be measured. In any case, it may be useful to restitute the position of its center C instead of the position of its surface. According to an embodiment of the invention, the center C of a spherical object 410 is restituted using the reflection of a light on the object 410 and some known acquisition conditions. A light source 414, e.g. a flash light, illuminates the object 410 and produces a light spot C′ on the object 410. A first camera 412 and a second camera (not shown) each acquires an image of the object 410. The light spot C′ is located on the images. The position of the light spot C′ is restituted using the images and a known relative position of the cameras. If the light source 414 is located near the optical axis of each of the cameras 412, the position of the center C can be approximated by assuming that the light source 414 is located on the optical axis of the camera 412. According to this approximation, the position of the center C is located at a distance corresponding to the known radius R of the object 410 from the light spot C′.

According to an embodiment, the position of the center C is corrected to take into account the fact that that the light source 414 is not rigorously located on the optical axis of the camera 412. The position of the center of the object 410 is calculated as follows: A line FC′ crosses the focal point F of the camera and the light spot C′. A line LC′ crosses the focal point L of the light source and the light spot C′. A line S crosses the light spot C′ and is located halfway between line LC′ and line FC′. The 3D position of the center C of the spherical object 410 is located on line S, at a distance R from the light spot C′ and away from the camera.

Furthermore, the position of the center C of the object 410 can be refined performing the same calculations with the second camera and averaging the positions of the centers C obtained with the first camera and with the second camera.

It should be noted that since the light spot C′ seen by each of the cameras is not rigorously at the same 3D position, the light spot C′ as described herein cannot be rigorously restituted. Accordingly, a correction method can be provided. An approximate position of C″ is calculated in the image, using a 2D translation of the point C′ initially identifying in the image by the vector equivalent to the projection of the vector C′-C onto the image plane. An approximate position of the 3D center is then calculated by photogrammetry using the C″ points of each camera. It should be noted that the figures are not drawn to scale and therefore, the sphere's size and its distance to the camera is smaller than in reality. In addition, the above calculations are used for a two-camera approach. The process is an approximate inversion of the real error. The algorithm can be repeated to obtain better precision. The algorithm is based on the known light source focal point (L), the camera's focal point F, and the sphere radius R.

In an embodiment, each of the cameras has its own light source, proximate to the camera's optical axis. A first image is acquired with the first camera while its light source is “on” and the other light source is “off” and a second image is acquired with the second camera while its light source is “on” and the other light source is “off”. In another embodiment, a single pair of camera-light source is used and the images are taken with distinct positions of the pair.

It is contemplated that while in the embodiments described above 3D points are restituted using at least two 2D images, one of the 2D images could be replaced by a calibrated projection, i.e. a 2D pattern or coded light projected on the object with known position, pattern, focal point and focal length. A triangulation technique can be used to retrieve 3D points from a pair of 2D data sets, one 2D data set being a known 2D light pattern, a coded light or such, projected on an object to be measured and the other 2D data set being a 2D image of the object including the result of the projected light. Features of the projected light are located on the 2D image and using a known position and orientation between the projection light source and the camera along with photogrammetric methods, 3D points are restituted.

The embodiments of the invention described above are intended to be exemplary only. The scope of the invention is therefore intended to be limited solely by the scope of the appended claims.

What is claimed is:

1. A method for determining a position of a center of a spherical object being imaged, the method comprising:
illuminating said spherical object using at least one light source to produce a light spot on said spherical object;
acquiring at least two two-dimensional images of said spherical object with at least two image acquisition devices having known relative positions;
calculating three-dimensional coordinates of said light spot using said at least two two-dimensional images; and
determining said position of said center by identifying a point located one radial distance from said light spot and away from said camera.

2. A method as claimed in claim 1, wherein said determining said position of said center comprises:
(a) defining a first line crossing a focal point of a first one of said at least two acquisition devices and said light spot;
(b) defining a second line crossing a focal point of said light source and said light spot;
(c) defining a third line crossing said light spot and positioned halfway between said first line and said second line; and
(d) identifying said point a radial distance away from said light spot and lying on said third line.

3. A method as claimed in claim 2, wherein said determining said position of said center comprises repeating steps (a), (b), (c), and (d) for a second one of said at least two image acquisition devices and averaging positions of said point for both cameras to determine said center of said spherical object.

4. A method for determining a position of an image acquisition device, the method comprising:
a. acquiring a 2D image comprising at least three features having known referent distances;
b. defining projection rays crossing each one of said features on said image and a known focal point of said image acquisition device;
c. arbitrarily choosing at least three points on said projection rays in front of said image acquisition device, said points having measurable relative current distances;
d. iteratively correcting positions of said at least three points on said projection rays by:
i. defining a corrective coefficient k for each one of said at least three points by defining a ratio of a summation of said referent distances to a summation of said current distances, and
ii. translating said at least three points along said projection rays using said corrective coefficient k; and
e. determining said position of said image acquisition device by performing a reference frame transformation.

5. A 3D acquisition system for determining a 3D position of a feature in a scene, the system comprising:
a light source having at least one of a light pattern projector for providing a projected pattern feature and a coded light projector for providing a coded light feature, said feature being one of said projected pattern feature, said coded light feature and a feature intrinsic of said scene;
an image acquisition device for acquiring a first 2D data set of said scene; and
an engine for locating said feature on said first 2D data set and on a second 2D data set and for determining said 3D position of said feature using said first and said second 2D data sets, said first and said second data sets being taken from different points of view, said engine having at least two of a projected pattern engine for said projected pattern feature, a coded light engine for said coded light feature, and an intrinsic feature engine said feature intrinsic to said scene,

6. The system as claimed in claim 5, wherein said second 2D data set comprises a known light figure projection.

7. The system as claimed in claim 5, wherein said image acquisition device is further for acquiring said second 2D data set of said scene.

8. The system as claimed in claim 5, further comprising a Geometric Dimensioning & Tolerancing module for modeling a geometric shape of an object in said scene for inspection of said object.

9. A method for reconstructing an object from a plurality of two-dimensional images of said object, said method comprising:
providing a set of parameters for features of said object, said parameters including at least one of shape and size;
acquiring said plurality of images from different angles;
reconstructing a set of points in three dimensions using standard photogrammetric techniques for said plurality of two-dimensional images;
recalculating two-dimensional coordinates in said images by performing pattern recognition between features in said images and said parameters in accordance with appropriate feature-to-camera distances; and
repeating said reconstructing using said two-dimensional coordinates determined using pattern recognition.

10. A method as claimed in claim 9, wherein said plurality of images are taken with varying focal and exposure settings.

11. A method as claimed in claim 10, wherein the best images from said plurality of images are chosen either manually or by an automated process.

12. A method as claimed in claim 10, wherein the focal and exposure settings of the images are chosen by acquiring images on a calibrated artifact.

13. A method as claimed in claim 10, wherein the best images from said plurality of images are chosen by finding the pair of images that provides the best match according to a correlation coefficient.

14. A method as claimed in claim 9, wherein said parameters are provided dynamically.
